(19) United States
(12) Patent Application Publication
(10) Pub. No.: US 2020/0388135 A1
(43) Pub. Date: Dec. 10, 2020

(54) AUTOMATED WATER BODY AREA MONITORING

(71) Applicant: DIPSEE.AI LTD., Modiin (IL)

(72) Inventors: YANIV VAKNIN, MODIIN (IL); OVADYA MENADEVA, MODIIN (IL); NIR VAKNIN, ASHDOD (IL)

(21) Appl. No.: 16/892,443

(22) Filed: Jun. 4, 2020

Related U.S. Application Data
(60) Provisional application No. 62/856,823, filed on Jun. 4, 2019.

(51) Int. Cl. G08B 21/08; G06T 7/62

(52) U.S. Cl. CPC G08B 21/08; G06T 7/20; G06T 7/62

(57) ABSTRACT

A method including receiving at least one image stream depicting a scene, processing the image stream to detect multiple parameters associated with at least (i) one or more persons in the scene, (ii) one or more objects in the scene, and (iii) one or more environmental conditions in the scene, where each of the parameters has an associated score, calculating an alert value with respect to the scene based on a weighted sum of the scores, and issuing an alert when the alert value is above a predefined threshold.

### CROSS-REFERENCE TO RELATED APPLICATIONS

This application claims the benefit of priority from U.S. Provisional Patent Application No. 62/856,823, filed on Jun. 4, 2019, the disclosure of which is incorporated herein by reference.

### FIELD

The invention relates to the field of computer vision and/or deep learning.

### BACKGROUND

Video based surveillance systems may be used as a tool for monitoring public and/or private sites, for example, for security and/or safety needs. Visual monitoring capabilities may be employed in many different locations, e.g., railway stations, airports, and/or dangerous environments, for example, to help people live more safely.

One important environment in which a need for monitoring systems is recognized is a water body environment. The World Health Organization (WHO) classifies drowning as a third leading cause of unintentional injury worldwide. Each year many children and adults drown or come very close to drowning in open water (e.g. ocean, lakes) or swimming pools. Globally, the highest drowning rates are found among children aged between 1 to 4 years, followed by children aged between 5 to 9 years.

Studies have shown that lifeguards may not be trained well enough to handle a drowning situation. Additionally, residential swimming pools may, e.g., typically, not employ a lifeguard. Hence, it may be advantageous to provide an automated drowning detection system in open water or swimming pools, for example, to promote swimming pool safety and/or minimize drowning rates.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a method comprising: receiving at least one image stream depicting a scene; processing said image stream to detect a plurality of parameters associated with at least: (i) one or more persons in said scene, (ii) one or more objects in said scene, and (iii) one or more environmental conditions in said scene, wherein each of said parameters has an associated score; calculating an alert value with respect to said scene based on a weighted sum of said scores; and issuing an alert when said alert value is above a predefined threshold.

There is also provided, in an embodiment, a system comprising at least one imaging device; at least one hardware processor; and a non-transitory computer-readable storage medium having stored thereon program instructions, the program instructions executable by the at least one hardware processor to: receive, from said imaging device, at least one image stream depicting a scene; process said image stream to detect a plurality of parameters associated with at least: (i) one or more persons in said scene, (ii) one or more objects in said scene, and (iii) one or more environmental conditions in said scene, wherein each of said parameters has an associated score; calculate an alert value with respect to said scene based on a weighted sum of said scores; and issue an alert when said alert value is above a predefined threshold.

There is further provided, in an embodiment, a computer program product comprising a non-transitory computer-readable storage medium having program instructions embodied therewith, the program instructions executable by at least one hardware processor to receive at least one image stream depicting a scene; process said image stream to detect a plurality of parameters associated with at least: (i) one or more persons in said scene, (ii) one or more objects in said scene, and (iii) one or more environmental conditions in said scene, wherein each of said parameters has an associated score; calculate an alert value with respect to said scene based on a weighted sum of said scores; and issue an alert when said alert value is above a predefined threshold.

In some embodiments, the method further comprises determining, and the program instructions are further executable to determine, a restricted area within said scene, based, at least in part, on detecting a boundary of a swimming pool or other body of water, such as, an ocean in said area.

In some embodiments, said restricted area comprises a specified margin along at least some of said boundary.

In some embodiments, said parameters associated with said one or more person are selected from the group consisting of: age, size, identity, an authorization status, bodily position, number of persons present, geographical location, physical activity, trajectory of motion, and velocity of motion.

In some embodiments, said physical activity is at least one of swimming, floating, jumping, running, sitting, standing, and lying down.

In some embodiments, said parameters associated with said objects are selected from the group consisting of: swimming aids, and presence of beverage bottles.

In some embodiments, said parameters associated with said environmental conditions are selected from the group consisting of: time of day, day of the week, date, season, current ambient temperature, current precipitation, current light conditions.

In some embodiments, method further comprises receiving, and the program instructions are further executable to receive, an indication regarding a correspondence between said alert value and said plurality of parameters.

In some embodiments, method further comprises updating, and the program instructions are further executable to update, said scores based, at least in part, on said indication.

In one embodiment a method is provided for detecting a swimmer in an unsafe event. The method includes receiving at least one image stream depicting a scene which includes a water body and processing the image stream to detect and track a person in the scene and to estimate foam around the person. A status of the person is calculated based on the processing of the image stream and an alert may be issued based on the calculated status of the person.

In another embodiment, an unsafe environmental condition, such as a rip current at a beach, is detected from the image stream. In one embodiment, the water line at the beach is detected from image information. Presence of a rip current is detected based on fusion of image information and non-image environmental information. Once a rip current is detected a signal may be issued. In one embodiment, a signal to generate an alert is issued if a person is detected in proximity to the detected rip current.

In addition to the exemplary aspects and embodiments described above, further aspects and embodiments will become apparent by reference to the figures and by study of the following detailed description.

### BRIEF DESCRIPTION OF THE DRAWINGS

Exemplary embodiments are illustrated in referenced drawing figures. Dimensions of components and features shown in the figures are generally chosen for convenience and clarity of presentation and are not necessarily shown to scale. The drawing figures are listed below, in which:

FIG. 1 shows a schematic illustration of an exemplary system for automated detection of unauthorized and/or unsafe entry, presence, and/or conduct of a person in a predefined restricted area, according to an embodiment;

FIG. 2 is a flowchart of functional steps implemented by a system for automated detection of unauthorized and/or unsafe entry, presence, and/or conduct of a person in a predefined restricted area, according to an embodiment;

FIG. 3 is a flowchart exemplifying a method for detecting unsafe conduct of a person in a predefined restricted area;

FIG. 4 schematically illustrates one example of a method for detecting the water line; and

FIG. 5 schematically illustrates a method for detecting a rip current.

### DETAILED DESCRIPTION

Described herein are a system, method, and computer program product for automated detection of unauthorized and/or unsafe entry, presence, and/or conduct of a person in a predefined restricted area.

In some embodiments, an automated algorithm of the present disclosure comprises a machine learning algorithm trained to detect such unauthorized and/or unsafe entry, presence, and/or conduct by one or more persons, for example, based on detecting at least some parameters associated with the persons, other persons in the area, the restricted area itself, a scene within the restricted area, and/or environmental conditions in the area.

In some embodiments, the present algorithm may offer real-time alerts with respect to ongoing unauthorized and/or unsafe entry, presence, and/or conduct events.

In some embodiments, the present algorithm may offer a prediction regarding imminent unauthorized and/or unsafe entry, presence, and/or conduct events.

In some embodiments, the present algorithm may be configured to reduce a number of false positives associated with such alerts and predictions.

In some embodiments, the present algorithm may be particularly useful, e.g., in the context of public and/or residential pools and/or any other swimming pools. However, the present algorithm may also be deployed, for example, within the context of any designated area where it may be desirable to detect unauthorized and/or unsafe entry, presence, and/or conduct.

In some embodiments, the present algorithm may be based, at least in part, on image detection and/or recognition techniques. In some embodiments, the present algorithm may provide accurate real time alerts, e.g., even if images of unauthorized and/or unsafe incidents include a plurality of persons, complex body positions, involved scenery, a variety of environmental conditions, and/or are captured at different angles and/or under different light and/or visibility conditions.

In some embodiments, the present algorithm may be configured to automatically detect and delineate an area and/or perimeter defining a restricted area, based, e.g., on detecting specified objects in the area.

In some embodiments, the present algorithm may enable a user to remotely monitor a restricted area, e.g., by receiving real time alerts at a predefined device, for example, including a smartphone, a tablet, or at any other alert medium, e.g., an alarm system. The alerts may be sent to the restricted area's owner and/or to any other user and/or person of interest, for example, a lifeguard rescuer and/or a parent.

In one example, the present algorithm may enable detection and/or tracking of an emergent, ongoing, and/or imminent drowning event of a person in various positions at indoor and/or outdoor, e.g., private or public, swimming pools.

In some embodiments, the present algorithm may be integrated into existing infrastructure, for example, existing camera surveillance systems and/or other camera fixtures which may provide coverage of a restricted area. In other embodiments, the present algorithm may include an independent set of cameras and/or imaging sensors, e.g., which is not based on existing infrastructure.

In some embodiments, the present algorithm may be configured to minimize a number of false alarms, e.g., based a machine learning algorithm which optimizes an alert and/or prediction function based on, e.g., user and/or other feedback to the system, wherein a user may indicate to the system whether an alert issued by the system was associated with an emergent, ongoing, and/or imminent.

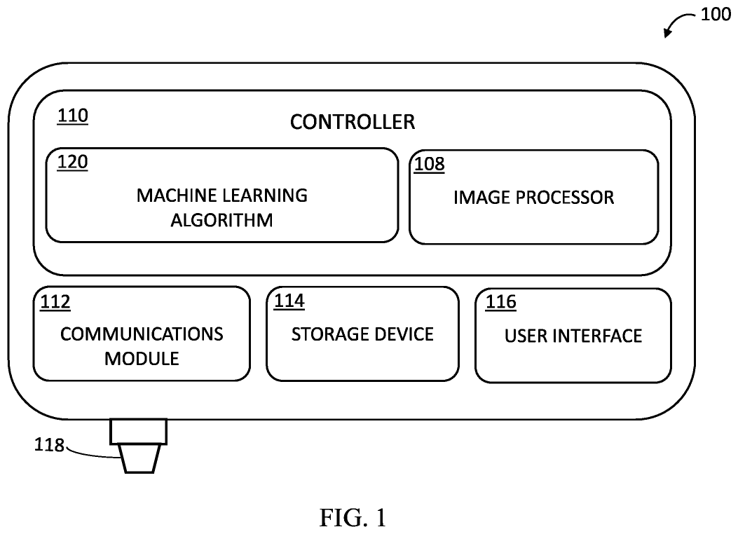

Reference is now made to FIG. 1, which is a schematic illustration of an exemplary system 100, according to the present disclosure. The various components of system 100 may be implemented in hardware, software or a combination of both hardware and software. system 100 as described herein is only an exemplary embodiment of the present algorithm, and in practice may have more or fewer components than shown, may combine two or more of the components, or a may have a different configuration or arrangement of the components.

In some embodiments, system 100 may include a controller 110 comprising one or more hardware processors, an image processor 108, a machine learning algorithm 120, a communications module 112, a memory storage device 114, a user interface 116, and/or an imaging sensor 118. In some embodiments, system 100 may include a sensors module comprising, e.g., proximity, acceleration, GPS, and/or similar or other sensors.

System 100 may store in a non-volatile memory thereof, such as storage device 114, software instructions or components configured to operate a processing unit (also “hardware processor,” “CPU,” or simply “processor). In some embodiments, the software components may include an operating system, including various software components and/or drivers for controlling and managing general system tasks (e.g., memory management, storage device control, power management, etc.) and facilitating communication between various hardware and software components.

In some embodiments, non-transient computer-readable storage device 114 (which may include one or more computer readable storage mediums) may be used for storing, retrieving, comparing, and/or annotating captured video frames and/or image frames. Image frames may be stored on storage device 114 based on one or more attributes, or tags, such as a time stamp, a user-entered label, or the result of an applied image processing method indicating the association of the frames, to name a few.

In some embodiments, communications module 112 may connect system 100 to a network, such as the Internet, a local area network, a wide area network and/or a wireless network. Communications module 112 facilitates communications with other external information sources and/or devices, e.g., external imaging devices, over one or more external ports, and also includes various software components for handling data received by system 100.

In some embodiments, user interface 116 may include circuitry and/or logic configured to interface between system 100 and a user of system 100. user interface 116 may be implemented by any wired and/or wireless link, e.g., using any suitable, Physical Layer (PHY) components and/or protocols.

In some embodiments, software instructions and/or components operating controller 110 may include instructions for receiving and/or analyzing multiple video frames and/or video streams captured by imaging sensor 118. For example, controller 110 may receive one or more video frames and/or video streams from imaging sensor 118 or from any other interior and/or external device and apply one or more image processing algorithms thereto.

In some embodiments, imaging sensor 118 may include one or more imaging sensors, for example, cameras, video surveillance systems, and/or any other imaging system, e.g., configured to capture one or more data streams, images, video frames, and/or videos streams, and/or to output captured data streams, images, video frames, and/or videos streams, for example, to enable identification of at least one object. In other embodiments, imaging sensor 118 may include an interface to an external imaging device, e.g., which may input one or more data streams and/or multiple video frames to system 100 via imaging sensor 118.

In some embodiments, controller 110 may be configured to perform and/or to trigger, cause, control and/or instruct system 100 to perform one or more functionalities, operations, procedures, and/or communications, to generate and/or communicate one or more messages and/or transmissions, and/or to control image processor 108, machine learning algorithm 120, communications module 112, memory storage device 114, user interface 116, imaging sensor 118, and/or any other component of system 100.

In some embodiments, controller 110 may be configured to implement one or more algorithms configured to perform object recognition, classification, segmentation, identification, alignment and/or registration, for example, in images and/or video streams captured by imaging sensor 118 or by any other interior and/or external device, using any suitable image processing or feature extraction technique. The image streams received by controller 110 may vary in resolution, frame rate, format, and protocol. Controller 110 may apply image stream processing algorithms alone or in combination.

In some embodiments, controller 110 may include image processor 108 configured to receive and/or process a plurality of video frames, and to determine a segmentation, classification, and/or identification according to one or more image processing algorithms and/or techniques.

In some embodiments, controller 110 may include machine learning algorithm 120 configured to receive and/or process multiple frames and/or multiple labels corresponding to the multiple frames from user interface 116, communications module 112 and/or imaging sensor 118. For example, machine learning algorithm 120 may be configured to train a neural network, e.g., a convolutional neural network, by utilizing the multiple frames and the multiple labels, for example, according to one or more optimization techniques and/or algorithms.

In other embodiments, system 100 may exclude communications module 112, user interface 116, imaging sensor 118, and/or any other component and/or sensor.

In some embodiments, system 100 may be configured to implement a danger-detection scheme, e.g., to enable real time detection and/or classification of events and/or incidents in a restricted area, e.g., as described below.

In some embodiments, controller 110 may be configured to cause image processor 108 and/or machine learning algorithm 120 to receive at least one video stream including a plurality of frames, e.g., each frame depicting at least one predetermined dangerous item, e.g., a swimming pool, in a restricted area, e.g., as described below.

In some embodiments, controller 110 may be configured to cause image processor 108 and/or machine learning algorithm 120 to detect a plurality of parameters related to the restricted area, for example, the plurality of parameters indicating a presence of at least one human, e.g., as described below.

In some embodiments, controller 110 may be configured to cause image processor 108 and/or machine learning algorithm 120 to track the at least one human, e.g., to determine at least one activity of the at least one human with respect to the dangerous item.

In some embodiments, controller 110 may be configured to cause image processor 108 and/or machine learning algorithm 120 to determine for the at least one human, based on the tracking and/or on the plurality of parameters, a corresponding danger probability.

In some embodiments, controller 110 may be configured to cause image processor 108 and/or machine learning algorithm 120 to transmit, upon determining that a danger probability of a human is above a threshold, at least one alert indicating the danger probability.

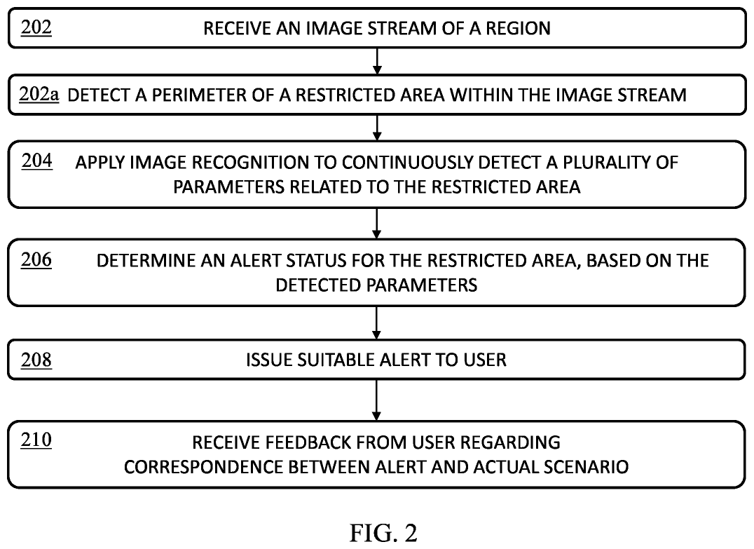

Reference is now made to FIG. 2, which is a flowchart illustrating exemplary functional steps performed by system 100 to implement automated detection of unauthorized and/or unsafe entry, presence, and/or conduct of a person in a predefined restricted area.

At a step 202, system 100 may be operated to monitor a restricted area. In some embodiments, upon starting system 100, imaging sensor 118, e.g., may obtain a continuous image stream of a region comprising the designated restricted area.

In some embodiments, at a step 202a, system 100 may be configured to detect within the region the perimeter and/or other boundaries of a restricted area. For example, in some embodiments, system 100 may be configured to detect a swimming pool within the region. System 100 may then be configured to detect a specified margin or boundary surrounding the pool, wherein the entire area may then be designated as the restricted area. In some embodiments, detecting a swimming pool may be based, e.g., on one or more unique features, e.g., water and/or lane drivers.

In some embodiments, a restricted area may be designated based on, e.g., detecting a fence and/or another perimeter surrounding the area. In some embodiments, a restricted area may be designated wholly or partially by a user of the system.

At step 204, the method may include applying image recognition techniques to perform continuous detection of a plurality of parameters related to the restricted area, including, for example, humans, objects, and environmental parameters.

In some embodiments, detection of one or more persons in the area may comprise classifying the persons according to, e.g., an age parameter which may take into account predefined sizes corresponding to an adult size and/or a child size, and/or any other age-related criteria.

In some embodiments, the recognition stage may include identifying each person in the restricted area as a person from one or more predefined lists, or as a non-listed person. A predefined list may include, for example, a risk list, an authorization list, and/or any other predefined list.

In one example, a risk list may include a listing of at least one predefined high-risk person, e.g., based on age, disability, swimming ability, and/or any other criteria.

In one example, an authorization list may include a listing of at least one predefined authorized person, e.g., an adult, and/or at least one predefined unauthorized person, e.g., a child.

In one example, a non-listed person may include a guest swimmer and/or any other person who is not mentioned in any predefined list.

In some embodiments, the recognition stage may include determining an escort parameter according to whether or not a detected person is alone in the restricted area and/or accompanied by an authorized person and/or any other person. For example, the escort parameter may indicate that the restricted area includes an unauthorized person alone, the restricted area includes a few unauthorized and/or high-risk people, or that the restricted area includes one or more unauthorized and/or high-risk people and at least one authorized person.

In some embodiments, the recognition stage may include classifying and/or recognizing body parts of each person in the restricted area. A detection of a body part of a person may be exact, e.g., not including only a bounding box around the entire person.

In some embodiments, after recognizing the body parts, the recognition stage may include determining a position and/or pose of each body part, e.g., a hand and/or a leg position, for example, with respect to the predefined dangerous and/or risky object, e.g., a swimming pool or open water. Determining the position and/or pose of each body part may provide valuable information, e.g., which may not exist in a normal bounding. For example, the information may be utilized to determine whether a head of a drowning person is above water or not.

In some embodiments, the recognition stage may include classifying and/or recognizing scene parameters, e.g., which may include any predefined object identified in the restricted area, e.g., besides people. The scene parameters may include, for example, the presence of swimming aids, or the presence of alcoholic beverages.

In some embodiments, the recognition stage may be implemented by a combination of image processor 108 and/or machine learning algorithm 120. In some embodiments, the recognition stage may be implemented by only one of image processor 108 and machine learning algorithm 120, e.g., independently.

In some embodiments, the recognition stage may combine and/or integrate computer vision, e.g., heuristic, non-neural network schemes and/or algorithms, e.g., implemented by image processor 108, with Artificial Intelligence (AI), e.g., deep learning, technologies and/or algorithms, e.g., implemented by machine learning algorithm 120.

In some embodiments, a combination and/or integration may yield a segmentation and/or classification of objects in a challenging environment, e.g., which may include, at a swimming pool zone, a large variety of possible swimming poses, presence of water ripples, shadows and splashes, different occlusions and/or light conditions, and/or any other obstacle and/or environmental complication.

In some embodiments, computer vision schemes, e.g., implemented by image processor 108, may be configured to detect persons, their body parts, scene parameters, a dangerous and/or risky predetermined object from a list of objects, and for each of person in the restricted area, an associated authorization and/or age parameters, position and/or pose parameters for each body part of the person, and/or any other related parameter.

In some embodiments, computer vision schemes, e.g., implemented by image processor 108, may include a semantic segmentation scheme, for example, which may be configured to cluster each pixel of a video frame, e.g., captured at the restricted area, into a specific class, for example, to enable identifying and/or tracking a set of predefined objects, for example, including humans, swimming pools, and/or any other object.

In some embodiments, a segmentation scheme may be configured to segment a video frame into several parts and/or sections, e.g., to enable discovery of at least one object of interest. After utilizing the semantic segmentation scheme to produce a segmented video frame, an object of interest may be detected, e.g., for tracking.

In some embodiments, a semantic segmentation scheme may include, e.g., at least a classification step, a localization and/or detection step, and/or a semantic segmentation step, e.g., as discussed below.

In some embodiments, the classification step may include making a prediction, for example, a coarse-grained prediction, for an input of video frames, e.g., according to a probability of each pixel of the video frames to belong to plurality of predetermined classes representing objects, for example, a person object, a swimming pool object, and/or any other object related to a danger scene, a swimming pool scene, and/or similar sceneries.

In some embodiments, the localization and/or detection step may be configured to determine a spatial location, e.g., an exact location in an image, of at least one object in the video frames. The localization and/or detection step may be implemented, e.g., with a bounding box which may be identified by numerical parameters, for example, with respect to an image's boundary.

In some embodiments, the semantic segmentation step may include making a plurality of predictions, for example, dense predictions, including predicting a class label for each pixel in the video frames, for example, so that each pixel may be labeled with a class of its enclosing object and/or region, for example, to achieve fine-grained inference. The semantic segmentation step may output for each video frame a corresponding pixel-level labeled video frame.

In some embodiments, in order to improve a classification and/or segmentation accuracy, the recognition stage may include receiving at least one predetermined input, e.g., a received frame including a swimming person, before starting a detection process of objects, for example, using the semantic segmentation scheme. The received frame may be chosen to be a suitable sample candidate of all frames, e.g., if the restricted area includes a swimming pool, the frame may be chosen to contain a person swimming in the swimming pool.

In some embodiments, the received frame may be required to include a full body image, e.g., a security-style image, for example, to ensure full recognition and/or identification of a swimming person. For example, an object of interest, e.g., a human body, may be extracted and marked, e.g., manually and/or automatically, for example, to enhance an accuracy of a detection process.

In some embodiments, predetermined input may enable the recognition stage to include recognizing and/or identifying swimmers in far imagery, for example, even if the swimmers are located more than two meters away from an imaging device, e.g., a video camera, thus enabling pedestrian recognition over a large space and/or area.

In some embodiments, computer vision schemes may include determining a position of a detected person, e.g., based on a gradient of a depth of pixels of the person object along a vertical axis, e.g., as calculated upon depth information which may be obtained, for example, from a depth camera.

In some embodiments, implementing a hard detection, e.g., using the semantic segmentation scheme and/or any other computer vision scheme, may enable locating and/or tracking each object in the restricted area, for example, accurately and/or precisely.

In some embodiments, in addition to and/or instead of the non-neural network computer vision schemes, the recognition stage may utilize deep learning technologies and/or schemes. A deep learning scheme may include a neural network classifier, e.g., a Convolutional Neural Network (CNN), which may be trained on a large labelled dataset to further optimize segmentation and/or classification.

In some embodiments, the large labelled dataset may include a plurality of images, e.g., at least 1000 images, each image depicting a restricted area, for example, with a swimming pool and/or any other determined danger, and/or at least one person instance, for example, to enable accurate and/or robust segmentation and/or classification, e.g., even in difficult conditions and/or scenes. In some embodiments, at least a portion of the dataset may comprise video sequences, e.g., comprising multiple individual image frames, depicting activity in a restricted area.

In some embodiments, an architecture of the neural network classifier may include an encoder network, e.g., a pre-trained classification network, followed by a decoder network, e.g., which may be configured to semantically project discriminative features, e.g., which may be learnt by the encoder network, onto a pixel space, for example, to get a dense classification. In one example, neural networks may be trained to classify near-drowning and/or normal swimming patterns.

In some embodiments, the neural network classifier may be trained to detect “people” objects, their body part, scene parameters, an escort situation, a dangerous and/or risky predetermined object, and for each of person in the restricted area, whether he belongs to any of the predefined lists, a related age parameter, position and/or pose parameters for each body part of the person, and/or any other related parameter.

In some embodiments, at a step 206, system 100 may be configured to continuously determine an alert status with respect to the restricted area.

In some embodiments, an alert status determination function may be configured to determine and/or predict an imminent unauthorized and/or unsafe entry, presence, and/or conduct events in the restricted area.

In some embodiments, the alert determination stage may output for every person in the restricted area a labeled danger and/or drowning probability, e.g., a 0% probability for a person may indicate that no danger is expected for the person, and a 100% probability may indicate a danger is extremely probable for the person.

In some embodiments, the alert determination stage may include determining emergent, ongoing, continuing, and/or imminent danger probabilities, for example, each having a separate and/or a same threshold. In some embodiments, each danger probability may provide a corresponding alert, for example, which may indicate a danger type and/or a scenario type.

In some embodiments, the alert determination stage may include determining and/or calculating danger and/or drowning probabilities with respect to one or more persons in the area, for example, based on a plurality of parameters obtained in step 204.

In some embodiments, the alert determination stage may receive, e.g., as an input, indications of persons and their body part, scene parameters, an escort situation, a segmented dangerous and/or risky object, and for each of the people objects, an indication as to whether they belong to any of the predefined lists, a related age parameter, and position and/or pose parameters for each body part.

In some embodiments, the input may be updated and/or changed continuously, e.g., corresponding to changes in received video frames.

In some embodiments, the alert determination stage may continuously update and/or determine a weight for each parameter of the plurality of parameters related to the restricted area, for example, according to changes in the received video frames corresponding to changes in the restricted area.

In some embodiments, the alert determination stage may include determining a state of the restricted area, e.g., from a plurality of predefined states. For example, the plurality of predefined states may include an idle state, e.g., when the restricted area is determined to be empty of people, a semi-active state, e.g., when the restricted area is determined to include a person in a non-dangerous area, e.g., sitting outside a swimming pool, and/or a fully active state, e.g., when the restricted area is determined to include at least one person in a dangerous area, e.g., inside the swimming pool.

In some embodiments, one or more components of system 100 may not be active and/or fully active during idle state and/or the semi-active state.

In other embodiments, system 100 may have any other predetermined state corresponding to any other scenario.

In some embodiments, the alert determination stage may include tracking each person in the zone, e.g., by tracking changes in his and/or his body parts' location, height and/or orientation.

In some embodiments, the tracking may include, e.g., finding a motion trajectory of the person as video frames proceed through time. This may be done by identifying a position of the object in every frame of the video and comparing them through time.

For example, tracking the person may include determining whether a swimming person and/or a head of the swimming person is underwater and/or disappeared in the water for a period which exceeds a threshold, and providing an alert if the period does exceed the threshold.

In some embodiments, the alert determination stage may include utilizing a determined position of a person and/or his body parts to predict a predefined activity of the person, e.g., based on a defined data sets and/or key rules. In one example, a person's pose may be used to determine whether he is swimming, standing, jumping, lying down, and/or any other predefined activity.

In some embodiments, the alert determination stage may include identifying movements, e.g., complicated movement, for example, a movement in which a head of a person is in a water surface level, but his face is under water, and/or pre-drowning distress-related movements indicating the person is about to drown.

For example, identifying a running pose towards a “ball” object may cause the alert determination stage to predict that the person will continue to run until reaching the ball.

In some embodiments, the alert determination stage may include determining danger and/or drowning probabilities, for example, based on identification of predefined objects in the restricted area, e.g., identifying alcohol-related objects may increase a drowning probability, but, for example, identifying swimming armbands and/or water wings, or any other safety equipment, may decrease a drowning probability.

In some embodiments, the alert determination stage may combine and/or integrate computer vision, e.g., heuristic, non-neural network schemes and/or algorithms, e.g., implemented by image processor 108, with Artificial Intelligence (AI), e.g., deep learning, technologies and/or algorithms, e.g., implemented by machine learning algorithm 120 based on a labeled dataset of video streams from at least one restricted area.

In some embodiments, a plurality of systems such as system 100 deployed in a plurality of restricted sites, may communicate, e.g., image streams and scene parameters to a central server.

In some embodiments, the server may be configured to save the plurality of image streams received from the from the plurality of video surveillance systems and to build and/or create a dataset including the plurality of video streams.

In one example, the dataset may include a large and/or dynamically growing dataset, e.g., including saved video streams that may be received continuously from a plurality of swimming pool environments and/or any other danger-related environment.

In another example, the dataset may include saved video streams that are received continuously from only one, e.g., specific restricted area, for example, a specific residential swimming pool.

In some embodiments, a CNN, e.g., machine learning algorithm 120, may train, e.g., periodically, on the large dataset.

In one example, every generated alert may be classified by a user as a false alert or a correct alert, and a corresponding scene and/or frame may be labeled according to the classification of the user. The CNN may receive as an input entire scenes and/or frames and corresponding falsely or correctly generated alerts and determine for each scene and/or frame a probability of generating an accurate alert. The CNN may adjust the determined probability according to the labeled scenes and/or frames and output a trained CNN classifier configured to classify an entire scene and/or frame as requiring an alert or not requiring an alert.

In some embodiments, the CNN classifier may utilize the labeled scenes and/or frames to minimize false alert positives and/or to provide an optimal and/or accurate danger and/or drowning probability when receiving a video stream and/or frame as an input.

In some embodiments, a large dynamic dataset of swimming pool environments for training a neural network may be unique and/or uncommon, e.g., enabling annotation, integration and/or optimization of danger detection.

In some embodiments, the dataset may include, e.g., in addition to the plurality of video streams received at the server, any image of danger and/or swimming pool environments, for example, which may be acquired, collected, analyzed, and/or added to the dataset manually and/or automatically, e.g., to improve a functionality of the danger-detection system.

In some embodiments, at step 208, system 100 may be configured to issue a suitable alert associated with the alert status detected in step 206. For example, system 100 may issue an alert through user interface 116. In some embodiments, an alert may be communicated by system 100 externally, e.g., through communications module 112, e.g., to a mobile device, a monitoring station, and the like.

In some embodiments, at a step 210, system 100 may be configured to train a machine learning algorithm to optimize one or more of the weights assigned to each parameter based on, e.g., user feedback. For example, a user of system 100 may indicate to the system whether an alert issued by system 100 corresponded to an actual scenario observed by the user. In some embodiments, a continuous training scheme may be based on a feedback received from a plurality of systems, such as system 100, deployed in a plurality of sites.

In one example, when an unauthorized person is identified in the restricted area, a corresponding drowning probability may increase. In an exemplary scenario, a small child may enter a swimming pool area unaccompanied by an adult. In some embodiments, system 100 may detect an age parameter, and/or identify an actual child form a predefined list. In such circumstances, system 100 may determine an alert status corresponding to these parameters, and issue a suitable alert. In another example, if an old person is detected swimming alone, a corresponding age parameter may be classified as “old” and a corresponding escort parameter may be classified as “alone,” and accordingly a drowning probability for the old person may increase.

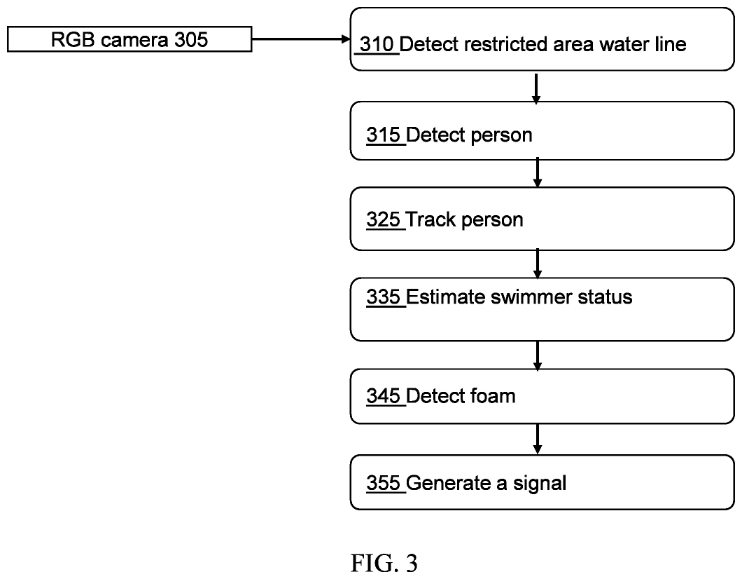

In one embodiment, which is schematically illustrated in FIG. 3, a method is provided for detecting a swimmer or other person in distress within a restricted area (e.g., beyond the water line in a pool, pond, sea, ocean or other water body).

In one embodiment images are receives from a camera, e.g., RGB, typically video camera 305 at a processor, such as image processor 108. The processor detects a restricted area (310), e.g., as described above, by detecting a boundary of the area, such as a water line at a beach or other water body. A restricted area may be an area in which it is unsafe for people to enter, an area where unauthorized people should not enter, etc. The processor then uses object detection techniques to detect (315) and track (325) a person, such as a swimmer, within the restricted area. For example, a person may be detected using deep learning detection algorithm, for example YOLO, and the person may be tracked over time, for example by using a SORT tracking algorithm to estimate a person's velocity and position.

A person detected beyond water line or inside the body of water can be marked as a swimmer.

The status of a swimmer (e.g., is the swimmer standing, partly covered, head visible, etc.) may then be estimated (335), for example, by defining a region of interest (ROI) and detecting ROI properties such as size and or ROI aspect ratio.

The status of a swimmer may be estimated also based on a posture of the swimmer, e.g., by using a pose estimation neural network algorithm e.g. PoseNet to determine hands position and/or head covered or not, etc.

The processor then estimates foam in vicinity of (e.g., surrounding) the swimmer (345).

A signal may be generated (355) based on the estimated status of the swimmer and/or based on estimation of foam in vicinity of the swimmer. For example, a “help signal” may be generated in case a swimmer is covered by water and a hand waving gesture is detected. In another exemplary case swimmer velocity is below a predetermined value that was determined as floating speed and/or the swimmer is isolated and/or foam is detected in vicinity of the swimmer. A signal generated in these cases may cause, for example, highlighting the swimmer's location in the display monitor of a user interface device such as user interface 116 and/or sounding an alert sound and/or sending an SMS and/or sending a video clip or image of the time that the event was detected.

In some embodiments, when an alert or other signal is generated, as described above, this can trigger communication with an auxiliary device such as a drone or rescue robot. The auxiliary device may receive and/or transmit information (such as location, images of the scene, etc.) from/to a processor, according to embodiments of the invention. Thus, a processor may control the auxiliary device using the communicated information to enable full cycle autonomous lifeguarding.

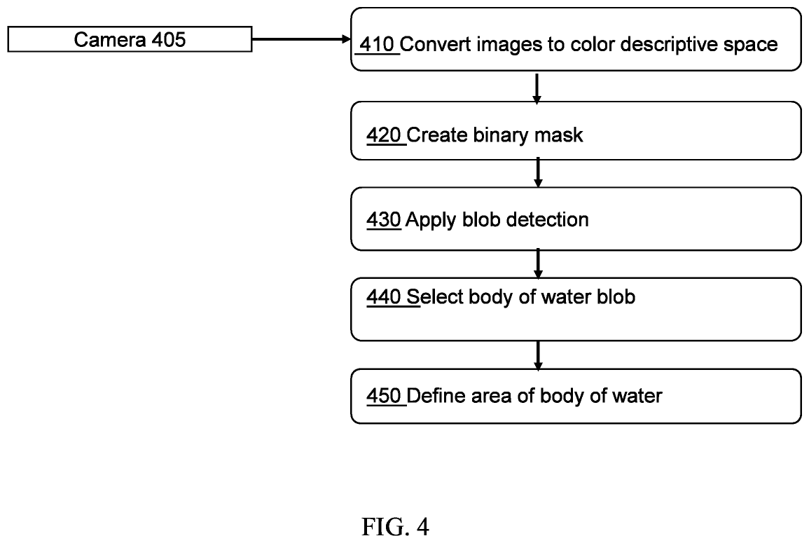

FIG. 4 schematically illustrates one example of a method for detecting the water line, (e.g., at the sea). In one embodiment the beach part is segmented by setting the range of the color pixels and blob detection is used in order to detect the beach component.

In one embodiment images are obtained from a video camera 405. The images are converted into color descriptive space (410) such as HSV or YUV or using other image space conversions. Color descriptive space such as HSV is closer to how humans perceive color. It has three components: hue, saturation, and value. This color space typically better describes colors.

A binary mask is created (420) from the converted image, e.g., by using range limitation or a lookup table or other mathematical descriptor such as mixture of Gaussians and obtaining a Mask Image in binary format.

A blob detection algorithm is applied (430) to find connected components. A single blob (connected component) is selected as the body of water blob (440) according to blob property such as blob area size or blob shape.

The contour of the body of water blob defines the body of water area (450).

Another method that can be used to detect the body of water (e.g. open water/pool) includes deep learning semantic segmentation, using, for example, a U shape neural network architecture. In semantic segmentation each pixel in an image is associated to a class label. The Class label can be, for example, Sea, Beach, person, etc.

Other known semantic segmentation algorithms can be used.

A possible unsafe event in the sea is a rip current, often simply called a rip, which is a specific kind of water current that can occur near beaches with breaking waves. A rip is a strong, localized, and narrow current of water which moves directly away from the shore, cutting through the lines of breaking waves like a river running out to sea. A rip current is strongest and fastest nearest the surface of the water.

Some features of rip currents include lack of regular wave movement and/or darker watercolor and/or foam.

In one embodiment, a fusion of two layers of technology is used to detect a rip. The first layer includes the use of image processing, e.g., using neural networks, and the second layer includes the use of marine models based on typically environmental information, such as, wind velocity and direction, wave motion and altitude, etc.

A system according to embodiments of the invention obtains images from a camera having a field of view of a coastal area near a beach in a non-swimming area that is at risk of formation a rip current. The system may issue an alert when these currents appear.

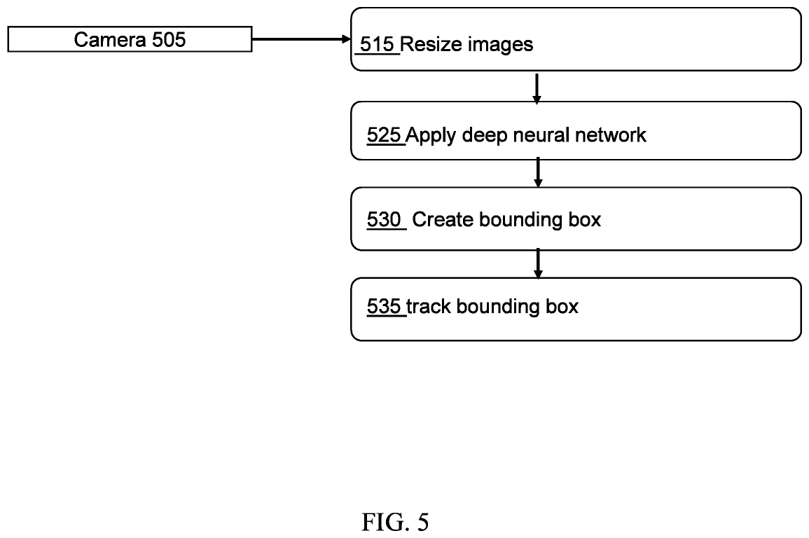

FIG. 5 schematically illustrates a method for detecting a rip current, according to embodiments of the invention.

In this exemplary method images are obtained from a video camera 505. The images are resized into smaller dimension (515), e.g., by using bi-linear interpolation or another image resizing algorithm. A deep neural network is used to detect a rip current (525) from the re-sized images. Detection of a rip current can cause a bounding box to be created around the rip current (530) and the bounding box may then be tracked (535), e.g., by using a moving average.

Once a rip current is detected a signal may be issued, e.g., to generate an alert, if a person is detected in proximity to the detected rip current.

Embodiments of the invention may include algorithms, systems, methods, and/or a computer program products. The computer program product may include a computer readable storage medium (or media) having computer readable program instructions thereon for causing a processor to carry out aspects of the present algorithm.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present algorithm may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present algorithm.

Aspects of the present algorithm are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of modified purpose computer, special purpose computer, a general computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present algorithm. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present algorithm have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving at least one image stream depicting a scene;
processing said image stream to detect a plurality of parameters associated with at least:
(i) one or more persons in said scene,
(ii) one or more objects in said scene, and
(iii) one or more environmental conditions in said scene,
wherein each of said parameters has an associated score;
calculating an alert value with respect to said scene based on a weighted sum of said scores; and
issuing an alert when said alert value is above a predefined threshold.

2. The method of claim 1, further comprising determining a restricted area within said scene, based, at least in part, on detecting a boundary of a swimming pool in said area.

3. The method of claim 2, wherein said restricted area comprises a specified margin along at least some of said boundary.

4. The method of claim 1, wherein said parameters associated with said one or more person are selected from the group consisting of: age, size, identity, an authorization status, bodily position, number of persons present, geographical location, physical activity, trajectory of motion, and velocity of motion.

5. The method of claim 4, wherein said physical activity is at least one of swimming, floating, jumping, running, sitting, standing, and lying down.

6. The method of claim 1, wherein said parameters associated with said objects are selected from the group consisting of: swimming aids, and presence of beverage bottles.

7. The method of claim 1, wherein said parameters associated with said environmental conditions are selected from the group consisting of: time of day, day of the week, date, season, current ambient temperature, current precipitation, current light conditions.

8. The method of claim 1, further comprising receiving an indication regarding a correspondence between said alert value and said plurality of parameters.

9. The method of claim 8, further comprising updating said scores based, at least in part, on said indication.

10. A system comprising:
at least one imaging device;
at least one hardware processor; and
a non-transitory computer-readable storage medium having stored thereon program instructions, the program instructions executable by the at least one hardware processor to:
receive, from said imaging device, at least one image stream depicting a scene,
process said image stream to detect a plurality of parameters associated with at least:
(i) one or more persons in said scene,
(ii) one or more objects in said scene, and
(iii) one or more environmental conditions in said scene,
wherein each of said parameters has an associated score,
calculate an alert value with respect to said scene based on a weighted sum of said scores, and
issue an alert when said alert value is above a predefined threshold.

11. The system of claim 10, wherein said instructions are further executable to determine a restricted area within said scene, based, at least in part, on detecting a boundary of a swimming pool in said area.

12. The system of claim 11, wherein said restricted area comprises a specified margin along at least some of said boundary.

13. The system of claim 10, wherein said parameters associated with said one or more person are selected from the group consisting of: age, size, identity, an authorization status, bodily position, number of persons present, geographical location, physical activity, trajectory of motion, and velocity of motion.

14. The system of claim 13, wherein said physical activity is at least one of swimming, floating, jumping, running, sitting, standing, and lying down.

15. The system of claim 10, wherein said parameters associated with said objects are selected from the group consisting of: swimming aids, and presence of beverage bottles.

16. The system of claim 10, wherein said parameters associated with said environmental conditions are selected from the group consisting of: time of day, day of the week, date, season, current ambient temperature, current precipitation, current light conditions.

17. The system of claim 10, wherein said instructions are further executable to receive an indication regarding a correspondence between said alert value and said plurality of parameters.

18. The system of claim 17, wherein said instructions are further executable to update said scores based, at least in part, on said indication.

19. A computer program product comprising a non-transitory computer-readable storage medium having program instructions embodied therewith, the program instructions executable by at least one hardware processor to:
receive at least one image stream depicting a scene;
process said image stream to detect a plurality of parameters associated with at least:
(i) one or more persons in said scene,
(ii) one or more objects in said scene, and
(iii) one or more environmental conditions in said scene,
wherein each of said parameters has an associated score;
calculate an alert value with respect to said scene based on a weighted sum of said scores; and
issue an alert when said alert value is above a predefined threshold.
